(19) United States
(12) Patent Application Publication
(10) Pub. No.: US 2026/0316280 A1
(43) Pub. Date: Oct. 15, 2026

(54) MULTI-COUPLER CONNECTION DEVICE

(71) Applicant: HANYANG ENG CO., LTD., Hwaseong-si, Gyeonggi-do (KR)

(72) Inventors: Joo-In KIM, Hwaseong-si, Gyeonggi-do (KR); Chul-Hong LEE, Hwaseong-si, Gyeonggi-do (KR); Min-Woo LEE, Hwaseong-si, Gyeonggi-do (KR)

(73) Assignee: HANYANG ENG CO., LTD., Hwaseong-si, Gyeonggi-do (KR)

(21) Appl. No.: 19/485,576

(22) PCT Filed: Jun. 27, 2024
(86) PCT No.: PCT/KR2024/009037

§ 371 Date: Nov. 18, 2025

(30) Foreign Application Priority Data
Jun. 28, 2023 (KR) 10-2023-0083654
Nov. 17, 2023 (KR) 10-2023-0159752

(51) Int. Cl. B25J 9/16; F16L 1/09; F16L 1/10

(52) U.S. Cl. CPC B25J 9/1679; B25J 9/1697; F16L 1/09; F16L 1/10

(57) ABSTRACT

A multi coupler connection device for connecting a supply-side coupler of a supply hose brought into an interior of any one of a plurality of door units corresponding to each of a plurality of storage units each storing different chemicals with a storage-side coupler of any one of the plurality of storage units, includes: an articulated robot that moves and connects the supply-side coupler with the storage-side coupler; a transfer unit that moves the articulated robot in a direction in which the plurality of storage units are disposed; and a vision unit that captures images to detect a position or type of the supply-side coupler and/or the storage-side coupler.

### CROSS-REFERENCE TO PRIOR APPLICATIONS

This Application is a National Stage Patent Application of PCT International Application No. PCT/KR 2024/009037 (filed on Jun. 27, 2024), which claims priority to Korean Patent Application Nos. 10-2023-0083654 (filed on Jun. 28, 2023) and 10-2023-0159752 (filed on Nov. 17, 2023), which are all hereby incorporated by reference in their entirety.

### BACKGROUND

The present invention relates to a multi coupler connection device, and more particularly, to a multi coupler connection device for connecting various types of supply hoses used for supplying different chemicals to a chemical storage unit that stores a corresponding chemical among a plurality of chemical storage units.

Generally, in chemical usage sites that use various chemicals, such as semiconductor factories or chemical factories, a chemical storage unit including a storage tank is provided.

Recently, in the process of supplying chemicals from a tank lorry carrying chemicals to a chemical storage facility through a supply hose, a so-called Automatic Clean Quick Coupler (ACQC) system has been used to automatically connect a coupler of the supply hose and a coupler of the chemical storage unit in order to protect workers from the harmfulness or danger of chemicals and to improve work efficiency.

A conventional automatic clean quick coupler system is provided for each type of chemical as shown in Korean Patent Publication No. 10-2023-0050169. In this case, a coupler connection device including a guide rail, a drive unit rail, and a drive unit for connecting the coupler of the supply hose to a corresponding connector is provided for each type of chemical. Accordingly, there has been a problem that the investment cost for automation is excessively increased.

### SUMMARY

The problem to be solved by the present invention is to provide a multi coupler connection device capable of automatically connecting couplers of various types of supply hoses.

The problems of the present invention are not limited to the problems mentioned above, and other problems not mentioned will be clearly understood by those skilled in the art from the following description.

To achieve the above object, a multi coupler connection device according to an embodiment of the present invention for connecting a supply-side coupler of a supply hose brought into an interior of any one of a plurality of door units corresponding to each of a plurality of storage units each storing different chemicals with a storage-side coupler of any one of the plurality of storage units comprises: an articulated robot that moves and connects the supply-side coupler with the storage-side coupler; a transfer unit that moves the articulated robot in a direction in which the plurality of storage units are disposed; and a vision unit that captures images to detect a position or type of the supply-side coupler and/or the storage-side coupler.

To achieve the above object, a multi coupler connection device according to an embodiment of the present invention for connecting a supply-side coupler of a supply hose brought into an interior of any one of a plurality of door units corresponding to each of a plurality of storage units each storing different chemicals with a storage-side coupler of any one of the plurality of storage units comprises: an articulated robot that moves and connects the supply-side coupler with the storage-side coupler; a transfer unit that moves the articulated robot in a direction in which the plurality of storage units are disposed; and a vision unit to determine whether the supply-side coupler should be connected to the storage-side coupler.

Specific details of other embodiments are included in the detailed description and drawings.

According to the multi coupler connection device of the present invention, there are one or more of the following effects.

First, there is an advantage that coupler connection can be automated at low cost by connecting couplers of various supply hoses with a single coupler connection device.

Second, there is an advantage that couplers of various types of supply hoses can be connected using an articulated robot.

Third, there is an advantage that no separate complex equipment or mechanism is required by moving the articulated robot with an automated guided vehicle, and control is easy.

Fourth, there is an advantage that the articulated robot can accurately grip the coupler using the vision unit and precisely couple with the corresponding coupler after movement.

Fifth, there is an advantage that misfeeding of chemicals is prevented by recognizing the supply-side coupler to be connected with the storage-side coupler using the vision unit.

The effects of the present invention are not limited to the effects mentioned above, and other effects not mentioned will be clearly understood by those skilled in the art from the description of the claims.

### BRIEF DESCRIPTION OF THE DRAWINGS

FIG. 1 is a perspective view of a multi automatic clean quick coupler system according to an embodiment of the present invention.

FIG. 2 is a plan view of a multi automatic clean quick coupler system according to an embodiment of the present invention.

FIG. 3 is a side view of a multi automatic clean quick coupler system according to an embodiment of the present invention.

FIG. 4 is a perspective view of a multi coupler connection device according to an embodiment of the present invention.

FIG. 5 is an exploded perspective view of an articulated robot of a multi coupler connection device according to an embodiment of the present invention.

FIG. 6 is an exploded perspective view of an automated guided vehicle of a multi coupler connection device according to an embodiment of the present invention.

FIG. 7 is a bottom view of an automated guided vehicle of a multi coupler connection device according to an embodiment of the present invention.

FIGS. 8 to 10 are operation example diagrams of a multi coupler connection device according to an embodiment of the present invention.

### DETAILED DESCRIPTION

The advantages and features of the present invention and methods for achieving them will become clear by referring to the embodiments described in detail below together with the accompanying drawings. However, the present invention is not limited to the embodiments disclosed below but may be implemented in various different forms, and these embodiments are provided only to make the disclosure of the present invention complete and to fully inform those skilled in the art to which the present invention pertains of the scope of the invention, and the present invention is only defined by the scope of the claims. Like reference numerals refer to like elements throughout the specification.

Although first, second, etc. are used to describe various components, it goes without saying that these components are not limited by these terms. These terms are only used to distinguish one component from another, and unless specifically stated to the contrary, a first component may be a second component.

Throughout the specification, unless specifically stated to the contrary, each component may be singular or plural.

Hereinafter, that an arbitrary configuration is disposed “on the top (or bottom)” of a component or “on (or under)” a component may mean not only that the arbitrary configuration is disposed in contact with the top surface (or bottom surface) of the component, but also that another configuration may be interposed between the component and the arbitrary configuration disposed on (or under) the component.

Also, when a component is described as being “connected,” “coupled,” or “connected” to another component, it should be understood that the components may be directly connected or connected to each other, but another component may be “interposed” between each component, or each component may be “connected,” “coupled,” or “connected” through another component.

As used in this specification, the singular forms include plural forms unless the context clearly indicates otherwise. In this application, terms such as “comprises” or “includes” should not be construed as necessarily including all of the various components or various steps described in the specification, and it should be construed that some components or some steps may not be included, or additional components or steps may be further included.

Throughout the specification, “A and/or B” means A, B, or A and B unless specifically stated to the contrary, and “C to D” means C or more and D or less unless specifically stated to the contrary.

Hereinafter, the present invention will be described with reference to drawings for explaining a multi coupler connection device according to embodiments of the present invention.

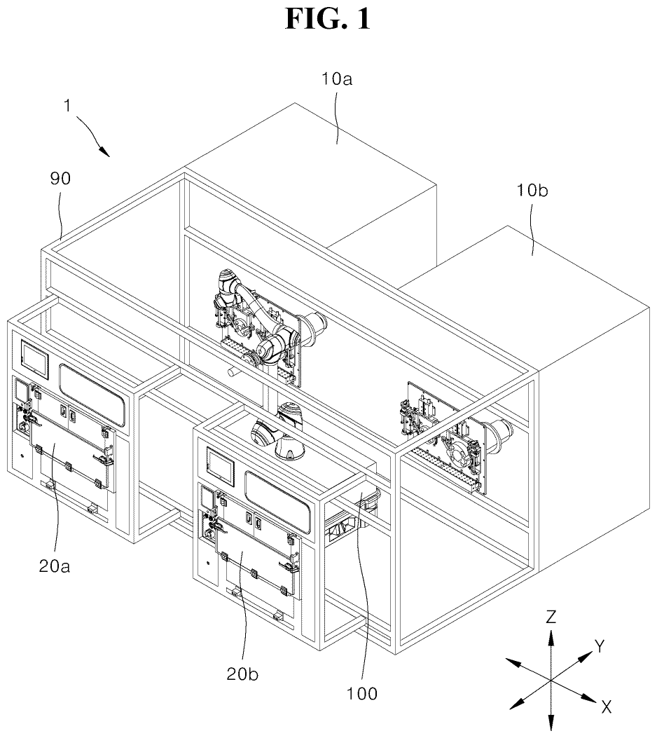

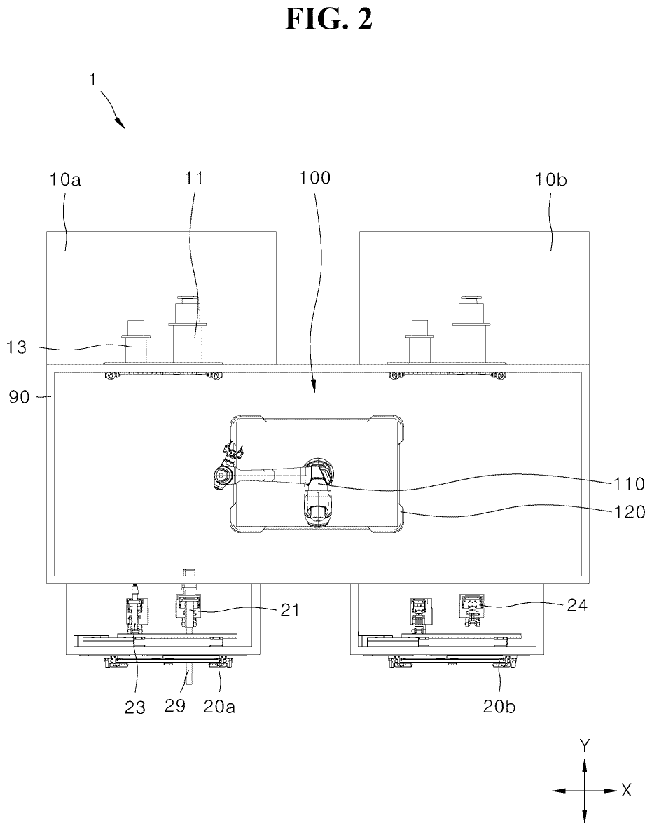

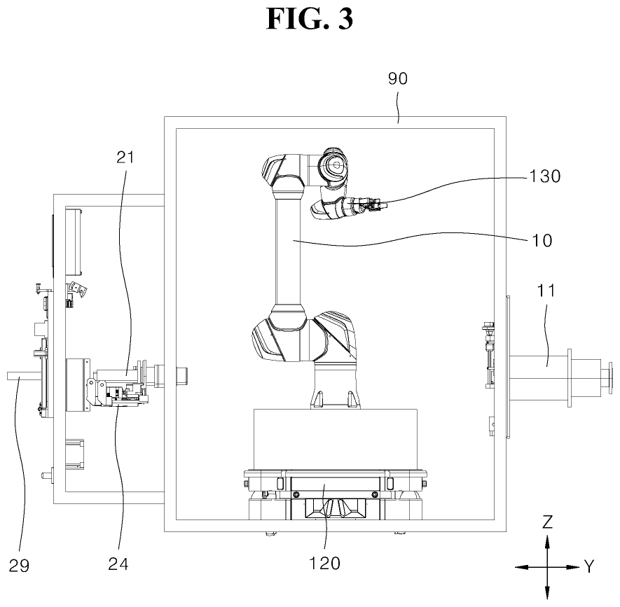

FIG. 1 is a perspective view of a multi automatic clean quick coupler system according to an embodiment of the present invention, FIG. 2 is a plan view of a multi automatic clean quick coupler system according to an embodiment of the present invention, and FIG. 3 is a side view of a multi automatic clean quick coupler system according to an embodiment of the present invention.

A multi automatic clean quick coupler system (1) according to an embodiment of the present invention includes: a plurality of storage units (10a, 10b) each storing different chemicals; a plurality of door units (20a, 20b) disposed corresponding to each of the plurality of storage units (10a, 10b) and into which a supply hose (29) of a tank lorry is brought; a supply-side coupler (21) provided at an end of the supply hose (29); a coupler holder (24) for holding the supply-side coupler (21); a storage-side coupler (11) provided in each of the plurality of storage units (10a, 10b) and connected to the supply-side coupler (21); a multi coupler connection device (100) that is brought into the interior of any one of the plurality of door units (20a, 20b) and connects the supply-side coupler (21) held on the coupler holder (24) with the storage-side coupler (11) of any one of the plurality of storage units (10a, 10b); and a shielding booth (90) that forms a space where the supply-side coupler (21) is connected to the storage-side coupler (11).

The plurality of storage units (10a, 10b) each store various types of chemicals. Each of the plurality of storage units (10a, 10b) includes a storage tank (not shown) that stores chemicals used in semiconductor factories or chemical factories. The plurality of storage units (10a, 10b) are disposed spaced apart in one direction (x direction). In this embodiment, two of the plurality of storage units (10a, 10b) are provided, and include a first storage unit (10a) that stores a first chemical, and a second storage unit (10b) that stores a second chemical.

Each of the plurality of storage units (10a, 10b) is provided with a storage-side coupler (11) to which the supply-side coupler (21) is connected, and a storage-side nitrogen coupler (13) to which nitrogen is supplied.

Each of the plurality of storage-side couplers (11) is disposed in each of the plurality of storage units (10a, 10b) and is connected to the supply-side coupler (21) of the supply hose (29) connected to the tank lorry so that the chemical stored in the tank lorry is stored in the storage tank. Each of the plurality of storage-side couplers (11) must be connected to the supply-side coupler (21) of the tank lorry in which the corresponding chemical is stored so that a specific chemical among various types of chemicals can be stored in the storage tank. Each of the plurality of storage-side couplers (11) is connected to the supply-side coupler (21) by the multi coupler connection device (100).

Each of the plurality of storage-side nitrogen couplers (13) is disposed in each of the plurality of storage units (10a, 10b) and is connected to the supply-side nitrogen coupler (23) connected to the tank lorry so that nitrogen stored in the nitrogen storage tank is stored in the tank lorry. Each of the plurality of storage-side nitrogen couplers (13) is connected to the supply-side nitrogen coupler (23) by the multi coupler connection device (100).

The plurality of storage-side couplers (11) and the plurality of storage-side nitrogen couplers (13) are disposed in pairs in each of the plurality of storage units (10a, 10b). After the storage-side coupler (11) and the storage-side nitrogen coupler (13) of any one storage unit (10a, 10b) among the plurality of storage units (10a, 10b) are connected to the supply-side coupler (21) and the supply-side nitrogen coupler (23) by the multi coupler connection device (100), nitrogen is supplied from the nitrogen storage tank to the tank lorry and the chemical stored in the tank lorry is stored in the storage tank.

Hereinafter, the multi coupler connection device (100) will be described as connecting the supply-side coupler (21) to the storage-side coupler (11), and the same description also applies to the multi coupler connection device (100) connecting the supply-side nitrogen coupler (23) to the storage-side nitrogen coupler (13).

Each of the plurality of door units (20a, 20b) is opened and closed so that the supply-side coupler (21) and the supply-side nitrogen coupler (23) of the tank lorry can be brought into the shielding booth (90). The plurality of door units (20a, 20b) are disposed spaced apart in a direction (x direction) in which the plurality of storage units (10a, 10b) are disposed. Each of the plurality of door units (20a, 20b) is disposed spaced apart in a direction (y direction) orthogonal to the x direction in correspondence with each of the plurality of storage units (10a, 10b). In this embodiment, two of the plurality of door units (20a, 20b) are provided, and include a first door unit (20a) disposed corresponding to the first storage unit (10a), and a second door unit (20b) disposed corresponding to the second storage unit (10b).

It is preferable that the plurality of door units (20a, 20b) are not opened simultaneously, and only any one door unit (20a, 20b) is opened so that only the supply-side coupler (21) and the supply-side nitrogen coupler (23) of the tank lorry are brought into the shielding booth (90).

The supply-side coupler (21) is provided at an end of the supply hose (29) of the tank lorry. The supply-side coupler (21) brought into the shielding booth (90) through any one of the plurality of door units (20a, 20b) is held on the coupler holder (24) and then moved by the multi coupler connection device (100) to be connected to the storage-side coupler (11).

The coupler holder (24) holds the supply-side coupler (21) brought into the door unit (20a, 20b). The supply-side coupler (21) is held on the coupler holder (24). The coupler holder (24) is supported by the door unit (20a, 20b), the shielding booth (90), or the floor of the shielding booth (90).

The supply-side nitrogen coupler (23) is provided at an end of a nitrogen hose (not shown) of the tank lorry. The supply-side nitrogen coupler (23) brought into the shielding booth (90) through any one of the plurality of door units (20a, 20b) is held on a nitrogen coupler holder (not shown) and then moved by the multi coupler connection device (100) to be connected to the storage-side nitrogen coupler (13).

The multi coupler connection device (100) is disposed between the plurality of storage units (10a, 10b) and the plurality of door units (20a, 20b). The multi coupler connection device (100) is configured so that the supply-side coupler (21) can be connected to the corresponding storage-side coupler (11) regardless of which of the plurality of door units (20a, 20b) the supply-side coupler (21) is brought in through.

The multi coupler connection device (100) includes: an articulated robot (110) that moves the supply-side coupler (21) to connect with the storage-side coupler (11); a transfer unit (120) that moves the articulated robot (110) in a direction (x direction) in which the plurality of storage units (10a, 10b) are disposed; and a vision unit (130) that captures images to detect a position or type of the supply-side coupler (21) and/or the storage-side coupler (11).

The articulated robot (110) grips the supply-side coupler (21) held on the coupler holder (24) and moves it. The articulated robot (110) moves the supply-side coupler (21) to connect with the storage-side coupler (11). It is preferable that the articulated robot (110) is a vertical articulated robot with 6 degrees of freedom or 7 degrees of freedom. The articulated robot (110) is moved by the transfer unit (120) in a direction (x direction) in which the plurality of storage units (10a, 10b) (or the plurality of door units (20a, 20b)) are disposed so that the distance from the supply-side coupler (21) held on the coupler holder (24) to the storage-side coupler (11) falls within the operating range. The articulated robot (110) is controlled by a direct teaching method, and images captured by the vision unit (130) can be utilized for accurate position detection.

The transfer unit (120) supports the articulated robot (110) and moves in a direction (x direction) in which the plurality of storage units (10a, 10b) (or the plurality of door units (20a, 20b)) are disposed. The transfer unit (120) moves the articulated robot (110) to the door unit (20a, 20b) that is opened and into which the supply-side coupler (21) is brought among the plurality of door units (20a, 20b). The transfer unit (120) is disposed between the plurality of storage units (10a, 10b) and the plurality of door units (20a, 20b).

The transfer unit (120) may be various equipment capable of moving the articulated robot (110), such as an Automated Guided Vehicle (AGV), an Autonomous Mobile Robot (AMR), a stage device, etc., and in this embodiment, the transfer unit (120) is an automated guided vehicle.

The automated guided vehicle (120) can be controlled by any one or a combination of two or more of the following known methods.

First, as an electromagnetic induction method, a magnet or an electromagnetic induction wire is embedded or attached along a preset travel path on the floor of the shielding booth (90), and the automated guided vehicle (120) determines the current position and travel path by detecting a magnetic field or electromagnetic field emitted or induced from the magnet or electromagnetic induction wire. To this end, the automated guided vehicle (120) includes at least one sensor for detecting a magnetic field or electromagnetic field at the bottom.

Second, as a vision recognition method, a predetermined marker is marked on the floor along a preset travel path on the floor of the shielding booth (90), and the automated guided vehicle (120) determines the current position and travel path by recognizing the marker. The marker may be, for example, a QR code, tape of a predetermined color attached continuously or discontinuously, or paint painted with a predetermined color. The automated guided vehicle (120) includes at least one code reader or camera sensor for detecting the marker.

Third, as a scanning method using electromagnetic waves (light) including infrared rays or lasers, the automated guided vehicle (120) emits electromagnetic waves, typically lasers, and detects electromagnetic waves reflected by objects disposed around to determine the current position and travel path. In particular, the automated guided vehicle (120) using the laser scanning method is called LGV (Laser Guided Vehicle). To this end, the automated guided vehicle (120) includes at least one scanner including a light emitting diode that emits electromagnetic waves and a light receiving diode that detects electromagnetic waves reflected by surrounding objects. In addition, to improve the recognition accuracy of surrounding objects, a reflector plate that reflects electromagnetic waves well may be provided on the surface of an object serving as a reference around the travel path.

The vision unit (130) captures images of a barcode or QR code (Quick Response code) attached to the supply-side coupler (21) and/or the storage-side coupler (11) to detect the position or type of the supply-side coupler (21) and/or the storage-side coupler (11). The vision unit (130) captures images of the barcode or QR code attached to the supply-side coupler (21) and the storage-side coupler (11) to recognize (confirm) the storage-side coupler (11) to be connected to the supply-side coupler (21).

It is preferable that the vision unit (130) captures images of a hole into which the chemical of the storage-side coupler (11) flows or a hole into which the supply-side coupler (21) is inserted to detect the exact position of the storage-side coupler (11) to be connected to the supply-side coupler (21).

The vision unit (130) may be disposed on the articulated robot (110) or the transfer unit (120), and in this embodiment, it is disposed on the articulated robot (110).

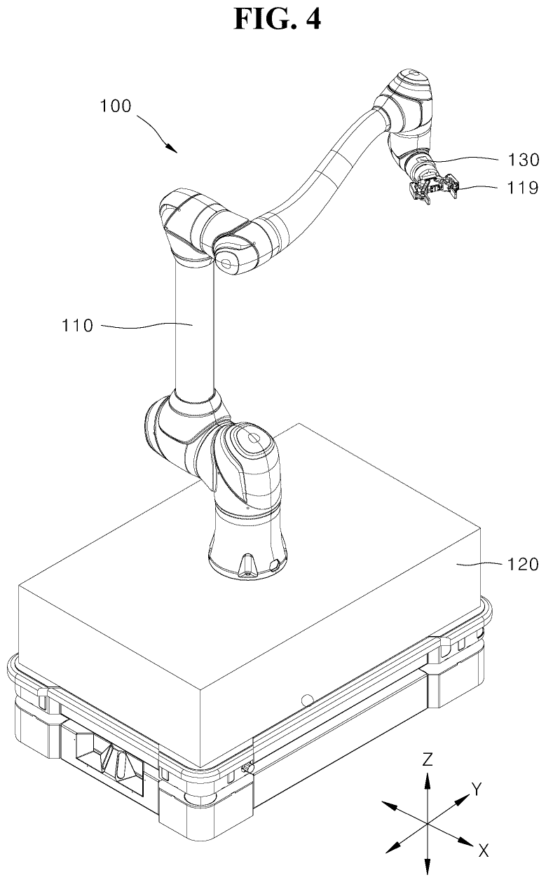

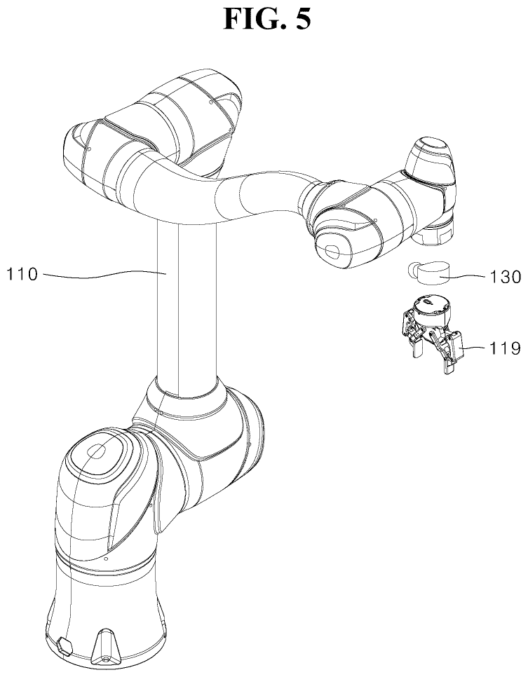

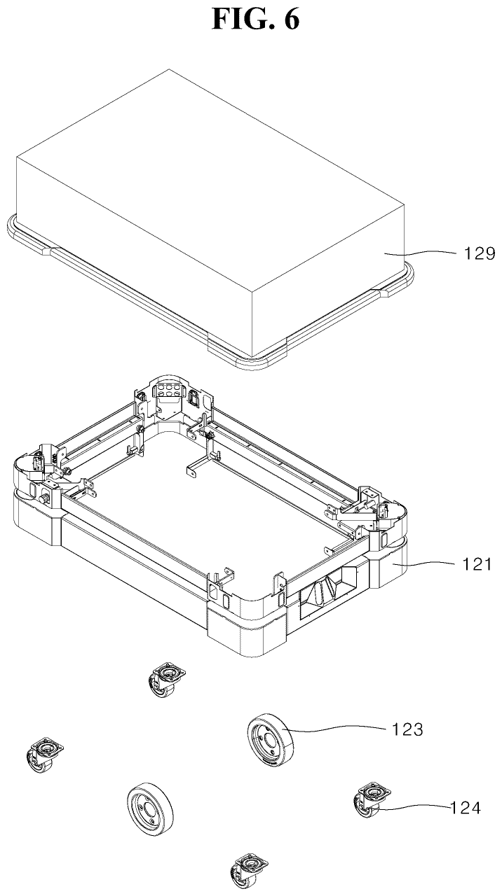

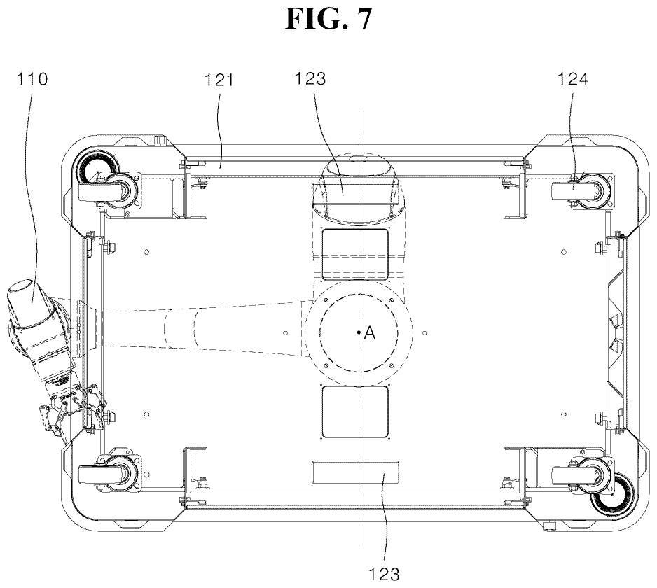

FIG. 4 is a perspective view of a multi coupler connection device according to an embodiment of the present invention, FIG. 5 is an exploded perspective view of an articulated robot of a multi coupler connection device according to an embodiment of the present invention, FIG. 6 is an exploded perspective view of an automated guided vehicle of a multi coupler connection device according to an embodiment of the present invention, and FIG. 7 is a bottom view of an automated guided vehicle of a multi coupler connection device according to an embodiment of the present invention.

Referring to FIGS. 4 and 5, the articulated robot (110) includes a gripper (119) that grips the supply-side coupler (21), and the vision unit (130) is disposed adjacent to the gripper (119). The vision unit (130) is disposed adjacent to the gripper (119) so that the position of the target object to be gripped by the gripper (119) can be measured relatively accurately from the captured image, and it has a high degree of freedom so that it can capture images in various postures and positions.

Referring to FIGS. 6 and 7, the automated guided vehicle (120) includes: a vehicle frame (121); a vehicle body (129) coupled to an upper portion of the vehicle frame (121) and supporting the articulated robot (110); a pair of vehicle drive wheels (123) coupled to the vehicle frame (121) and generating driving force; and a plurality of vehicle driven wheels (124).

The vehicle frame (121) forms the skeleton of the automated guided vehicle (120) and is formed in a substantially rectangular rim shape. The vehicle body (129) is coupled to the upper portion of the vehicle frame (121), and the pair of vehicle drive wheels (123) and the plurality of vehicle driven wheels (124) are coupled to the lower portion.

The vehicle body (129) is formed in a substantially rectangular parallelepiped box shape and forms the appearance of the automated guided vehicle (120). The vehicle body (129) supports the articulated robot (110). The vehicle body (129) is coupled to the vehicle frame (121), and inside are provided a motor (not shown) that generates power to rotate the pair of vehicle drive wheels (123), a battery (not shown) that supplies power to the motor, a controller (not shown) that controls the automated guided vehicle (120), etc. A communication module (not shown) for communication with the outside may be provided on the upper portion of the vehicle body (129).

The pair of vehicle drive wheels (123) are wheels that rotate by the motor, and generate driving force to move the automated guided vehicle (120). The automated guided vehicle (120) moves forward, backward, or rotates according to the rotation direction of the pair of vehicle drive wheels (123). The pair of vehicle drive wheels (123) are disposed at the center of each of the two long sides of the vehicle frame (121).

The plurality of vehicle driven wheels (124) are wheels that rotate according to the movement of the automated guided vehicle (120), and support the automated guided vehicle (120) so that it can move. Four of the plurality of vehicle driven wheels (124) are provided and disposed at each of the four corners of the vehicle frame (121).

The articulated robot (110) is relatively heavy and its center of gravity changes according to its movement, so stable support is required. In addition, it is preferable that the articulated robot (110) is disposed on the vehicle body (129) so that the weight is not biased to any one of the pair of vehicle drive wheels (123). Referring to FIG. 7, the articulated robot (110) is coupled to the vehicle body (129) at the midpoint (A) of a line connecting the rotation centers of the pair of vehicle drive wheels (123).

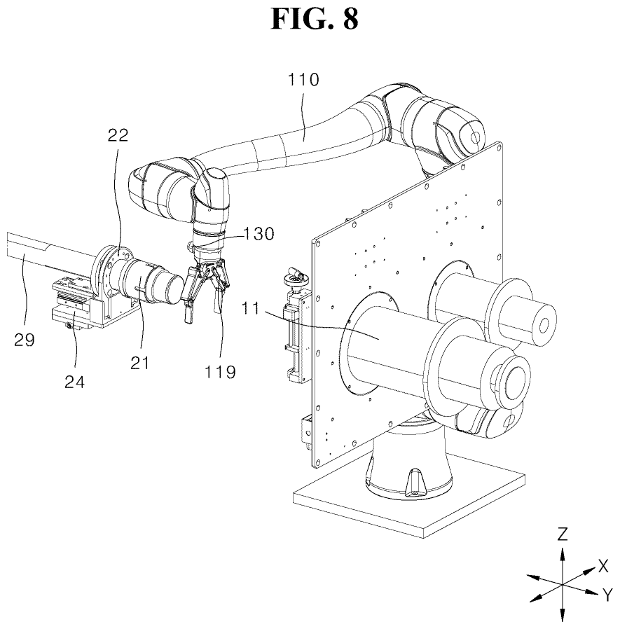

FIGS. 8 to 10 are operation example diagrams of a multi coupler connection device according to an embodiment of the present invention.

A tank lorry carrying a specific chemical stops in front of the door unit (20a, 20b) corresponding to the storage unit (10a, 10b) in which the corresponding chemical is stored among the plurality of door units (20a, 20b). After the door unit (20a, 20b) is opened and the supply hose (29) and supply-side coupler (21) of the tank lorry are brought into the shielding booth (90), they are held on the coupler holder (24). When the pair of vehicle drive wheels (123) of the automated guided vehicle (120) generate driving force, the automated guided vehicle (120) moves linearly in the x direction to move the articulated robot (110) to the door unit (20a, 20b) side into which the supply-side coupler (21) has been brought (the storage unit (10a, 10b) side where the specific chemical is to be stored).

When the movement of the articulated robot (110) by the automated guided vehicle (120) is completed, the articulated robot (110) operates so that the vision unit (130) can capture images of the supply-side code (22) attached to the supply-side coupler (21) as shown in FIG. 8. The supply-side code (22) is a barcode, QR code, or other marker. The vision unit (130) captures images of the supply-side code (22) to measure the position of the supply-side coupler (21) and recognize the type of the supply-side coupler (21).

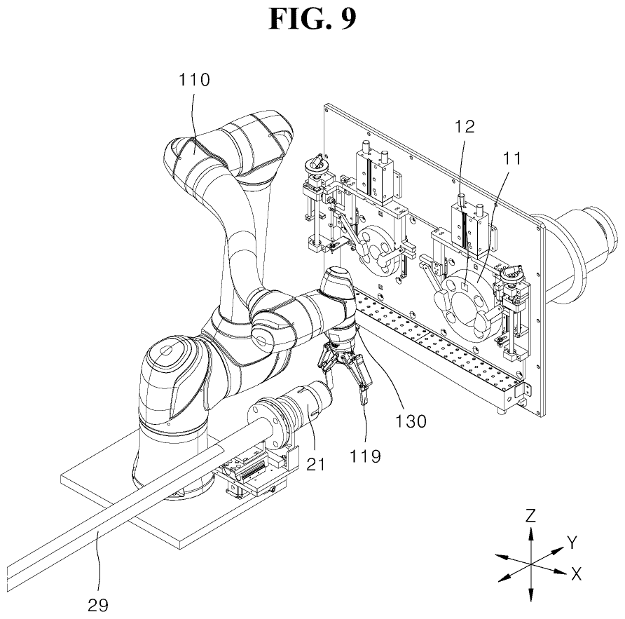

After capturing images of the supply-side code (22), the articulated robot (110) operates so that the vision unit (130) can capture images of the storage-side code (12) attached to the storage-side coupler (11) as shown in FIG. 9. The storage-side code (12) is a barcode, QR code, or other marker. The vision unit (130) captures images of the storage-side code (12) to measure the position of the storage-side coupler (11) and recognize the type of the storage-side coupler (11).

Through the supply-side code (22) and the storage-side code (12) captured by the vision unit (130), it is confirmed whether the supply-side coupler (21) should be connected to the storage-side coupler (11). This can prevent a specific chemical of the tank lorry from being supplied to a storage unit (10a, 10b) where a different chemical is to be stored.

According to embodiments, the vision unit (130) may capture images of the hole into which the chemical of the storage-side coupler (11) flows and/or the hole into which the supply-side coupler (21) is inserted. Accordingly, the articulated robot (110) is accurately controlled so that the supply-side coupler (21) can be aligned with the storage-side coupler (11).

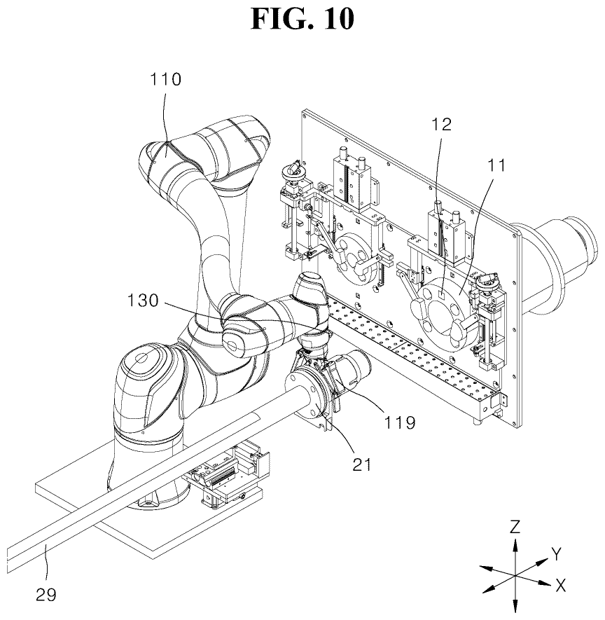

When recognition of the supply-side code (22) and the storage-side code (12) is completed, the articulated robot (110) grips the supply-side coupler (21) held on the coupler holder (24) with the gripper (119). After separating the supply-side coupler (21) from the coupler holder (24), the articulated robot (110) moves the supply-side coupler (21) in the y direction and couples it to the storage-side coupler (11) as shown in FIG. 10.

Through the above-described process, the articulated robot (110) couples the supply-side nitrogen coupler (23) to the storage-side nitrogen coupler (13). When the couplers are fastened, nitrogen is supplied to the tank lorry and the chemical stored in the tank lorry is supplied to the storage tank of the storage unit (10a, 10b).

After the supply of the chemical is completed, the articulated robot (110) separates the supply-side coupler (21) from the storage-side coupler (11), moves it, and places it on the coupler holder (24). In addition, it separates the supply-side nitrogen coupler (23) from the storage-side nitrogen coupler (13), moves it, and places it on the nitrogen coupler holder.

While the preferred embodiments of the present invention have been shown and described above, the present invention is not limited to the specific embodiments described above, and various modifications may be made by those skilled in the art to which the invention pertains without departing from the gist of the invention as claimed in the claims, and these modifications should not be individually understood apart from the technical spirit or perspective of the present invention.

1. A multi coupler connection device for connecting a supply-side coupler of a supply hose brought into an interior of any one of a plurality of door units corresponding to each of a plurality of storage units each storing different chemicals with a storage-side coupler of any one of the plurality of storage units, the device comprising:
an articulated robot that moves and connects the supply-side coupler with the storage-side coupler;
a transfer unit that moves the articulated robot in a direction in which the plurality of storage units are disposed; and
a vision unit that captures images to detect a position or type of the supply-side coupler and/or the storage-side coupler.

2. The multi coupler connection device of claim 1, wherein the articulated robot comprises a gripper that grips the supply-side coupler, and
the vision unit is disposed adjacent to the gripper. (Currently Amended) The multi coupler connection device of claim 1, wherein the vision unit captures images of a storage-side code attached to the storage-side coupler to detect the position of the storage-side coupler.

4. The multi coupler connection device of claim 1, wherein the vision unit captures images of a hole into which the chemical of the storage-side coupler flows to detect the position of the storage-side coupler.

5. The multi coupler connection device of claim 1, wherein the vision unit captures images of a supply-side code attached to the supply-side coupler to detect the position of the supply-side coupler.

6. The multi coupler connection device of claim 1, wherein the vision unit captures images of a storage-side code attached to the storage-side coupler and a supply-side code attached to the supply-side coupler to recognize the storage-side coupler to be connected to the supply-side coupler.

7. The multi coupler connection device of claim 1, wherein the transfer unit comprises:
a vehicle frame;
a vehicle body coupled to an upper portion of the vehicle frame and supporting the articulated robot; and
a pair of vehicle drive wheels coupled to the vehicle frame and generating driving force.

8. The multi coupler connection device of claim 7, wherein the articulated robot is coupled to the vehicle body at a midpoint of a line connecting rotation centers of the pair of vehicle drive wheels.

9. A multi coupler connection device for connecting a supply-side coupler of a supply hose brought into an interior of any one of a plurality of door units corresponding to each of a plurality of storage units each storing different chemicals with a storage-side coupler of any one of the plurality of storage units, the device comprising:
an articulated robot that moves and connects the supply-side coupler with the storage-side coupler;
a transfer unit that moves the articulated robot in a direction in which the plurality of storage units are disposed; and
a vision unit to determine whether the supply-side coupler should be connected to the storage-side coupler.
